(19) United States
(12) Patent Application Publication
(10) Pub. No.: US 2025/0301944 A1
(43) Pub. Date: Oct. 2, 2025

(54) NUTRIENT PLACEMENT SYSTEM FOR AN AGRICULTURAL IMPLEMENT AND METHOD OF OPERATION

(71) Applicant: CNH Industrial America LLC, New Holland, PA (US)

(72) Inventor: Michael Jacob Digman, Denver, PA (US)

(21) Appl. No.: 19/094,067

(22) Filed: Mar. 28, 2025

Related U.S. Application Data
(60) Provisional application No. 63/571,884, filed on Mar. 29, 2024.

(51) Int. Cl. A01C 21/00; A01C 15/00

(52) U.S. Cl. CPC A01C 21/007; A01C 15/005

(57) ABSTRACT

A nutrient placement system may include a plurality of dispensers configured to be supported on a frame of a row unit of an agricultural implement with each of the plurality of dispensers being configured to be positioned at least partially rearward of a respective ground-engaging tool of a plurality of ground-engaging tools of the row unit along a forward direction of travel such that the plurality of dispensers are spaced apart along the forward direction of travel. Each of the plurality of dispensers may be configured to selectively dispense one or more agricultural products onto the field worked by the respective ground-engaging tool. Additionally, the nutrient placement system may include a computing system configured to control operation of the nutrient placement system to selectively dispense the one or more agricultural products from the plurality of dispensers onto the field.

### CROSS REFERENCE TO RELATED APPLICATION

The present application is based upon and claims the right of priority to U.S. Provisional Patent Application No. 63/571,884 filed on Mar. 29, 2024, the entirety of which is incorporated by reference herein for all purposes.

### FIELD OF THE INVENTION

The present disclosure relates generally to agricultural implements and, more particularly, to nutrient placement systems for agricultural implements and methods of operation for such nutrient placement systems.

### BACKGROUND OF THE INVENTION

It is well known that, to attain the best agricultural performance from a field, a farmer must properly prepare the field, such as by performing a fertilizing operation and/or a tillage operation, separate of, or with, a planting operation. Fertilizing, tillage, and planting implements may include one or more ground-engaging tools configured to engage the soil as the implement is moved across the field to allow for nutrient placement below the surface of the field. Strip-based implements may have row units that only work narrow strips of the field, instead of working the entire field along the swath of the implement. Depending on the time of the year and/or field conditions present when a preparation operation is taking place, it may be desirable to change the depth and/or type of nutrient to be placed. However, conventional row units for strip-based implements may only provide one operating depth and/or type of nutrient to be placed at a time.

Accordingly, an improved nutrient placement system for an agricultural implement and related methods for operating such nutrient placement system would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural implement. The agricultural implement may include a chassis, a row unit, a nutrient placement system, and a computing system. The row unit may include a row unit frame supported on the chassis and a plurality of ground-engaging tools supported on the row unit frame, with each of the plurality of ground-engaging tools being configured to work a field to a respective penetration depth. The nutrient placement system may include a plurality of dispensers supported on the row unit frame, with each of the plurality of dispensers being positioned at least partially rearward of a respective ground-engaging tool of the plurality of ground-engaging tools along a forward direction of travel of the agricultural implement such that the plurality of dispensers are spaced apart along the forward direction of travel, and with each of the plurality of dispensers being configured to selectively dispense one or more agricultural products onto the field worked by the respective ground-engaging tool. The computing system may be configured to control operation of the nutrient placement system to selectively dispense the one or more agricultural products from the plurality of dispensers onto the field.

In another aspect, the present subject matter is directed to a nutrient placement system configured for an agricultural implement having a row unit including a row unit frame supported on a chassis and a plurality of ground-engaging tools supported on the row unit frame, each of the plurality of ground-engaging tools being configured to work a field to a respective penetration depth. The nutrient placement system may include a plurality of dispensers configured to be supported on the row unit frame, with each of the plurality of dispensers being configured to be positioned at least partially rearward of a respective ground-engaging tool of the plurality of ground-engaging tools along a forward direction of travel of the agricultural implement such that the plurality of dispensers are spaced apart along the forward direction of travel, and each of the plurality of dispensers being configured to selectively dispense one or more agricultural products onto the field worked by the respective ground-engaging tool. Additionally, the nutrient placement system may include a computing system configured to control operation of the nutrient placement system to selectively dispense the one or more agricultural products from the plurality of dispensers onto the field.

In a further aspect, the present subject matter is directed to a method of operating a nutrient placement system of an agricultural implement. The agricultural implement may include a row unit having a row unit frame supported on a chassis and a plurality of ground-engaging tools supported on the row unit frame, where each of the plurality of ground-engaging tools may be configured to work a field to a respective penetration depth. The nutrient placement system may include a plurality of dispensers supported on the row unit frame, where each of the plurality of dispensers may be positioned at least partially rearward of a respective ground-engaging tool of the plurality of ground-engaging tools along a forward direction of travel of the agricultural implement such that the plurality of dispensers are spaced apart along the forward direction of travel, and where each of the plurality of dispensers may be configured to selectively dispense one or more agricultural products onto the field worked by the respective ground-engaging tool. The method may include receiving, with a computing system, data indicative of field conditions within the field. Additionally, the method may include controlling, with the computing system, operation of the nutrient placement system to selectively dispense the one or more agricultural products from the plurality of dispensers onto the field based at least in part on the field conditions within the field.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a side view of another embodiment of a row unit suitable for use with the implement shown in FIG. 1 in accordance with aspects of the present subject matter;

FIG. 4 illustrates a side view of a further embodiment of a row unit suitable for use with the implement shown in FIG. 1 in accordance with aspects of the present subject matter;

FIG. 5 illustrates a side view of yet another embodiment of a row unit suitable for use with the implement shown in FIG. 1 in accordance with aspects of the present subject matter;

FIG. 6 illustrates a side view of an additional embodiment of a row unit suitable for use with the implement shown in FIG. 1 in accordance with aspects of the present subject matter;

FIG. 7 illustrates a schematic view of a system for performing a nutrient placement operation in accordance with aspects of the present subject matter; and

FIG. 8 illustrates a flow diagram of one embodiment of a method for performing a nutrient placement operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a nutrient placement system for an agricultural implement and methods for operating such nutrient placement system. More particularly, in several embodiments, a strip-based agricultural implement, such as a strip-based fertilizer applicator, a strip-based tillage implement, and/or a strip-based planting implement, may have one or more row units, where each row unit has a plurality of ground-engaging tools configured to work the field. The different ground-engaging tools may be configured to perform different ground-working operations (e.g., opening, tilling, berm-building, surface finishing, and/or the like), and, as such, may work the field at different depths, which may be adjustable. In accordance with particular aspects of the present subject matter, the row unit(s) of the strip-based agricultural implement may further be provided with a nutrient placement system, where the nutrient placement system is configured to selectively dispense one or more agricultural products (e.g., liquid and/or granular fertilizer) relative to (e.g., at or behind) two or more of the ground-engaging tools. Particularly, by dispensing at multiple locations on the row units of the strip-based agricultural implement, agricultural products may be provided at the most advantageous depths for supporting subsequent plant growth. For instance, it may be advantageous to place faster acting chemicals at shallower depths for supporting early plant growth, whereas it may be advantageous to place slower acting chemicals at deeper depths for supporting later-stage plant growth. Moreover, in some instances, the type of product being dispensed and/or the rate at which the product is being dispensed at each location may be controllable, for instance, based on the field conditions present, or expected to be present, within the field.

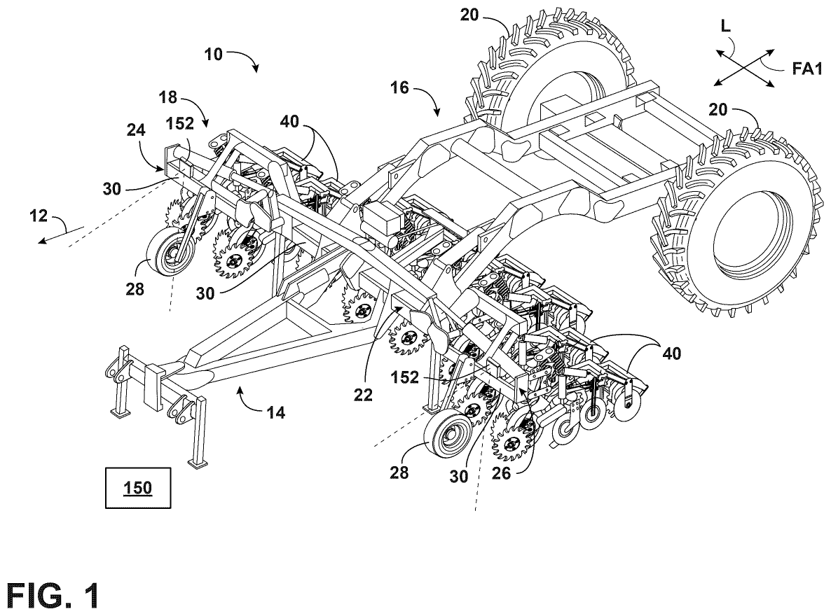

Referring now to the drawings, FIG. 1 illustrates a perspective view of one embodiment of an agricultural implement 10 in accordance with aspects of the present subject matter. In general, the agricultural implement 10 may be configured to be towed across a field in a forward direction of travel (e.g., as indicated by arrow 12 in FIG. 1) by a work vehicle (e.g., an agricultural tractor). As shown, the agricultural implement 10 is configured as a strip tillage implement. However, in other embodiments, the agricultural implement 10 may be configured as any other suitable type of implement, such as a seed-planting implement, a fertilizer-dispensing implement, and/or the like.

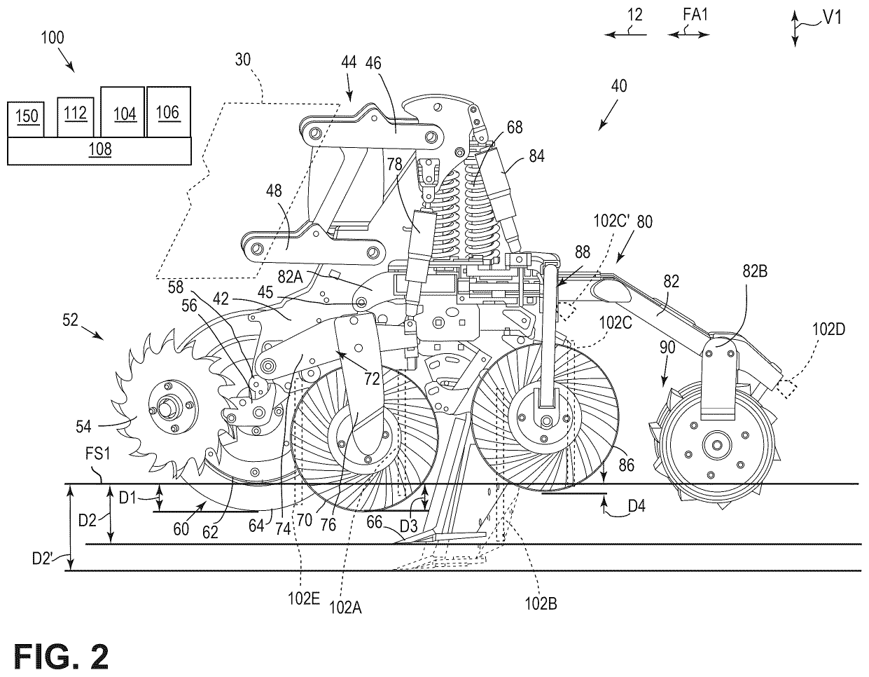

As shown in FIG. 1, the agricultural implement 10 includes a towbar assembly 14, a chassis assembly 16, and a toolbar assembly 18. In general, the towbar assembly 14 may be configured to allow the implement 10 to be coupled to a tow vehicle (e.g., a tractor) for towing the agricultural implement 10 along a field during the performance of a strip-tillage operation. For instance, the towbar assembly 14 may incorporate a hitch or other suitable coupling for connecting the agricultural implement 10 to a tow vehicle. In one embodiment, the chassis assembly 16 may be configured to support one or more storage tanks (e.g., storage tanks 104, 106 shown schematically in FIG. 2). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

In the illustrated embodiment, the chassis assembly 16 is positioned at the aft end of the implement 10 such that the toolbar assembly 18 is disposed between the towbar assembly 14 and the chassis assembly 16 along a longitudinal direction of the implement 10 (as indicated by arrow 21 in FIG. 1), with the longitudinal direction FAI extending generally parallel to the direction of travel 12. For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the longitudinal direction FAI of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in a lateral direction 23 that is generally perpendicular to the longitudinal direction FA1) from the central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may function as gauge wheels for the wing toolbar sections 24, 26.

In general, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shank or knife assemblies, finishing or conditioning units, and/or the like for tilling narrow strips of soil during the performance of a strip tillage operation. Additionally, as will be described below in greater detail, each row unit 40 may also incorporate one or more components for supplying agricultural materials to the soil, such as injectors or tubes for directing agricultural material (e.g., liquid fertilizer and/or granular fertilizer) supplied from storage tank(s) supported on the chassis assembly 16 or the row unit 40 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s)) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s)). However, in alternative embodiments, the frame 42 of the row unit 40 may be coupled to the toolbar 30 in any other suitable manner. Additionally, the row unit 40 may include one or more downforce actuators 50 (not shown) provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each row cleaner disc 54 being pivotably coupled to the main frame via a respective row cleaner arm 56. In general, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) coupled between the main frame 42 and a respective row cleaner arm 56. In one embodiment, the row cleaner actuators 58 may be passive actuators, such as air shocks or springs, configured to provide a downward biasing force against the row cleaner 52 to maintain engagement of the row cleaner discs 54 with the field surface FS1. Alternatively, the row cleaner actuators 58 may be actively controlled actuators, such as pneumatic or hydraulic cylinders, where the actuator(s) 58 may be controlled to adjust a position of the respective row cleaner disc 54 relative to the frame 42, and thus, adjust an aggressiveness of the contact between the row cleaner 52 and the field surface FS1. The row cleaner discs 54 are shown in a raised position in FIG. 2 above the surface of the field FS1.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction 23 of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit to a depth D1 within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a shank 66 mounted to the main frame 42 at a location aft of the central hub 62 relative to the forward direction of travel 12 of the implement 10. In one embodiment, the shank 66 may generally be aligned with the center coulter 60 in the lateral direction 23 of the implement 10. The shank 66 may be configured to break up the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders, to adjust the penetration depth that the shanks 66 extend beneath the surface of the field FS1. For instance, as shown FIG. 2, the shanks 66 are adjustable between a first penetration depth D2 and a second, deeper penetration depth D2′. Generally, the shanks 66 extend deeper than the center coulter 60. For instance, the shanks 66 may extend from 6 to 9 inches below the soil, or any other suitable range.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction 23 of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth D3 (e.g., 1-2 inches), compared to the shank 66, to create scores or fracture lines within the soil along the lateral edges of the row being formed. The shank 66 may, in turn, be configured to break up the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point. Each frame member 82 extends rearwardly from the pivot point relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction 23 of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth D4 (e.g., 1 inch or less), so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

Additionally, in accordance with aspects of the present subject matter, the row unit 40 may be provided with a nutrient placement system 100, where the nutrient placement system 100 is configured for selectively dispensing one or more agricultural products (e.g., liquid and/or granular fertilizer) relative to (e.g., at or behind) at least two of the ground-engaging tools (e.g., the center coulter 60, the first side coulters 70, the shank 66, the second side coulters 86, and/or the strip conditioner 90). The nutrient placement system 100 may include a plurality of dispensing devices 102 or “dispensers”, one or more product tanks (a first product tank 104 and a second product tank 106 being shown) configured to hold agricultural product(s) to be dispensed by the dispensing devices 102, a valving assembly 108 having a plurality of valves for controllable to selectively supply agricultural product(s) to the dispensing devices, and a distribution flow source 112 (e.g., a fan, a pump, and/or the like) for pressurizing the flow of agricultural product(s) for dispensing from the dispensing devices 102. It should be appreciated that the dispensing devices 102 may include any suitable tubing, piping, nozzles, and/or the like, where each of the dispensing devices 102 may have a respective inlet coupled to the valving assembly 108 and a respective outlet through which agricultural product(s) is dispensed onto the field. It should additionally be appreciated that, while only the two product tanks 104, 106 are shown, any other suitable number of product tanks may instead be included, such as only one tank, three tanks, four tanks, and/or the like.

For instance, as shown in FIG. 2, the dispensing devices 102 includes a first dispensing device 102A positioned at the first side coulters 70 (e.g., at least partially rearward thereof), a second dispensing device 102B positioned at the shank 66 (e.g., at least partially rearward thereof), a third dispensing devices 102C and a diffusing dispensing device 102C′ positioned at the second side coulters 86 (e.g., at least partially rearward thereof), a fourth dispensing device 102D positioned at the strip conditioner 90 (e.g., at least partially rearward thereof), and a fifth dispensing device 102E positioned at the central coulter 60 (e.g., at least partially rearward thereof).

The dispensing devices 102A, 102B, 102C, 102C′, 102D, 102E may be configured to dispense agricultural product(s) onto the field at depths associated with the respective tool. For example, the first dispensing device 102A may be configured to dispense agricultural product(s) down to the depth D3 into the cuts formed by the first side coulters 70. In such instance, the first dispensing device 102A may, in some embodiments, be at least partially positioned between the first side coulters 70. Similarly, the second dispensing device 102B may be configured to dispense agricultural product(s) down to the depth D2, D2′ into the opening formed by the shank 66. For instance, in some embodiments, the dispensing device 102B may extend along a rear side of the shank 66. Moreover, the third dispensing device 102C may be configured to dispense agricultural product(s) in the berm being formed by the second side coulters 86 working down to the depth D4. In some instances, the third dispensing device 102C may be at least partially positioned between the second side coulters 86. The diffusing dispensing device 102C′ may be configured to dispense agricultural product(s) on top of the berm after being formed by the second side coulters 86 but before the strip conditioner 90 works the berm. Similarly, the fourth dispensing device 102D may be configured to dispense agricultural product(s) on top of the field surface FS1 behind the strip conditioner 90. Additionally, the fifth dispensing device 102E may be configured to dispense agricultural product(s) in the cut formed by the central coulter 60 down to the depth D1. In some instances, the diffusing dispensing device 102C′ and the fourth dispensing device 102D may be configured as diffusing dispensing devices and the dispensing devices 102A, 102B, 102C, 102E may be configured as drop tube dispensing devices, where the diffusing dispensing device 102C′ and the fourth dispensing device 102D may configured to diffuse or provide a wider or less directed spray of the agricultural product(s) for more general coverage of the targeted areas than the drop-tube configuration of the other dispensing devices 102A, 102B, 102C, 102E. It should be appreciated that a diffusing device, like the diffusing device 102C′ and/or the fourth dispensing device 102D, may be provided instead of, or in addition to, one or more of the drop-tube dispensing device(s) 102A, 102B, 102C, 102E. Conversely, it should also be appreciated that, a drop-tube dispensing device, such as the drop-tube dispensing devices 102A, 102B, 102C, 102E, may be provided instead of, or in addition to, one or more of the diffusing device(s) 102C′, 102D.

It should be appreciated that while six dispensing devices 102 are shown in FIG. 2, the row unit 40 may be configured to have any suitable number and/or combination of the described dispensing devices 102. In particular embodiments, however, it is particularly desirable to have at least two different dispensing device locations on the row unit 40. Particularly, by dispensing at multiple locations on the row unit 40, agricultural products may be provided at the most advantageous depths for supporting subsequent plant growth. For instance, it may be advantageous to place faster acting chemicals at shallower depths for supporting early plant growth, whereas it may be advantageous to place slower acting chemicals at deeper depths for supporting later-stage plant growth.

Moreover, as will also be described below, a computing system 150 may be provided in communication with the valving assembly 108 and the distribution flow source 112. The computing system 150 may instruct or otherwise control the valving assembly 108 and the distribution flow source 112 such that the type of product being dispensed and/or the rate at which the product is being dispensed at each location may be varied, for instance, based on the field conditions present, or expected to be present, within the field, which may provide even better subsequent yields. As such, as will be described in greater detail below, in some embodiments, one or more sensor(s) 152 (FIG. 1) may also be provided in association with the agricultural implement 10, where the sensor(s) 152 may be configured to generate data indicative of the field conditions present within the field.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

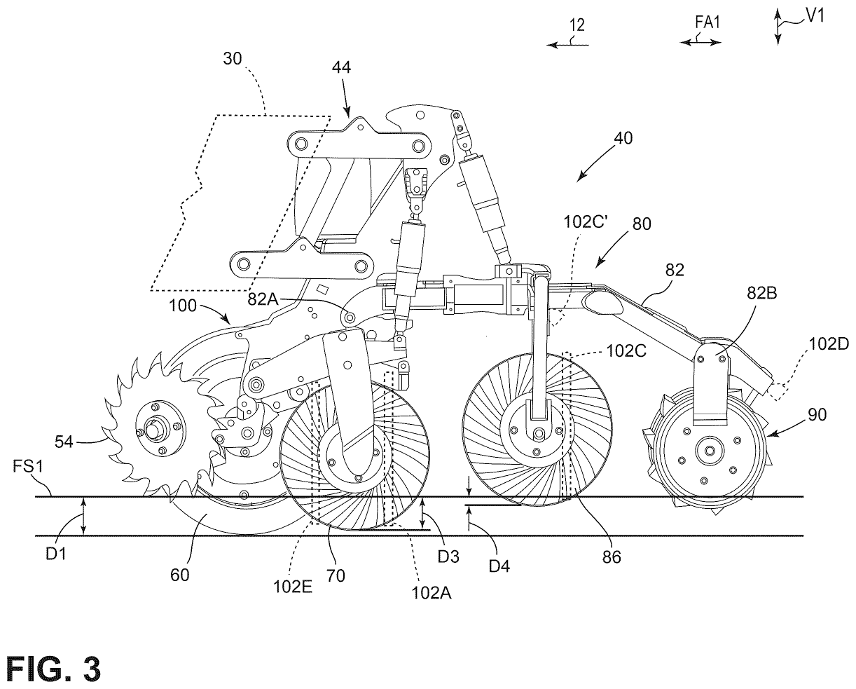

For instance, referring now to FIGS. 3-6, side views of various other row units suitable for use with the implement shown in FIG. 1 are illustrated in accordance with aspects of the present subject matter. The same reference numbers from FIG. 2 will be used for the same parts in FIGS. 3-6, where applicable. It should be appreciated that the number and/or combinations of dispensing devices 102 shown in FIGS. 3-6 are only to provide examples of suitable locations for dispensing devices 102, and that the row units 40 in FIGS. 3-6 may be configured to have any suitable number and/or combination of the described dispensing devices 102.

FIG. 3 illustrates a side view of a further row unit for use with the implement shown in FIG. 1. The row unit in FIG. 3 is configured substantially the same as the row unit 40 of FIG. 2, except that the row unit 40 in FIG. 3 is a coulter-only embodiment and does not include the shank 66 as in FIG. 2. As such, in the embodiment shown in FIG. 3, the second dispensing device 102B is omitted compared to the embodiment shown in FIG. 2.

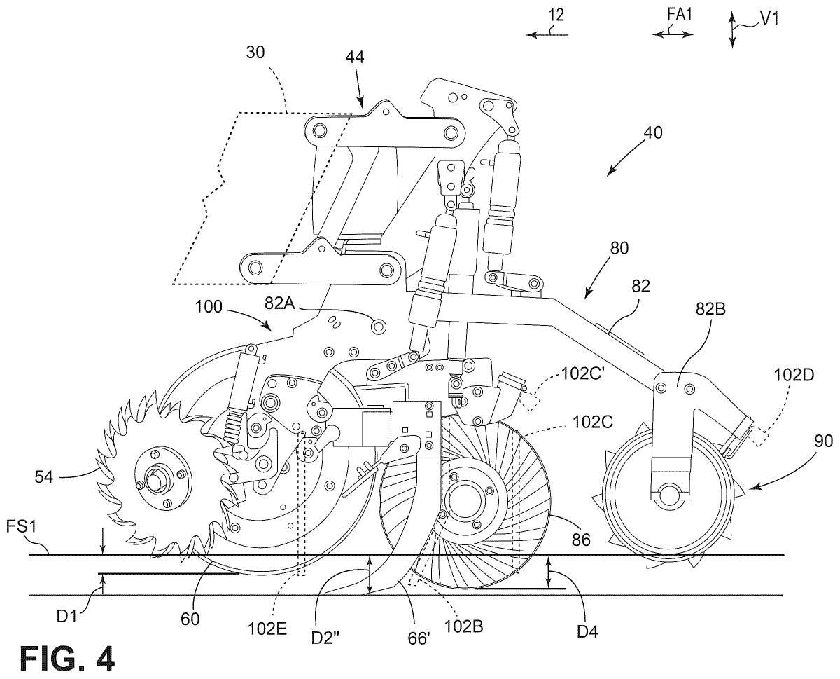

FIG. 4 illustrates a side view of another tillage row-unit for use with the implement shown in FIG. 1. Particularly, the row unit 40 in FIG. 4 is configured substantially similar to the row unit 40 of FIG. 2, except that the row unit 40 in FIG. 4 includes a knife 66′ instead of the shank 66 in FIG. 2, and that the first pair of side coulter discs 70 from FIG. 2 is not present in FIG. 4. For instance, the knife 66′ in the row unit 40 in FIG. 4 is generally between the center coulter 60 and forward of the side coulter discs 86 (one of the side coulter discs 86 being removed for visibility purposes) along the longitudinal direction FA1. As such, in the embodiment shown in FIG. 4, the first dispensing device 102A is omitted compared to the embodiment shown in FIG. 2.

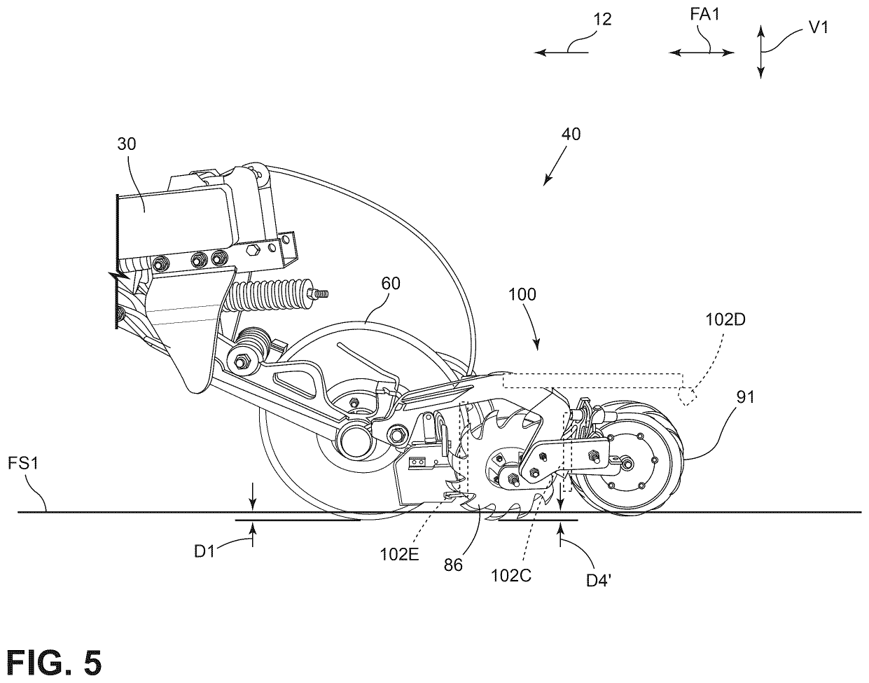

Further, FIG. 5 illustrates a side view of yet another embodiment of a row unit for use with the implement shown in FIG. 1. Unlike the tillage row units of FIGS. 2-4, the row unit 40 in FIG. 5 is configured as a fertilizer row unit. As such, the row unit 40 in FIG. 5 is configured to disturb the ground less than the tillage row units of FIGS. 2-4. Thus, the row unit 40 in FIG. 5 only includes the center coulter 60, the side coulter discs 86 (configured with fingers) generally aft of the center coulter 60 along the longitudinal direction FA1, and a packer wheel 91 generally aft of the side coulter discs 86 and configured to condition (e.g., smooth and/or flatten) the surface of the field after the row unit 40. As such, in the embodiment shown in FIG. 5, the first dispensing device 102A and the second dispensing device 102B are omitted compared to the embodiment shown in FIG. 2. Moreover, it should be appreciated that instead of, or in addition to, the third dispensing device 102C, the diffusing dispensing device 102C′ (FIG. 2) may be used between the side coulter discs 86 and the packer wheel 91.

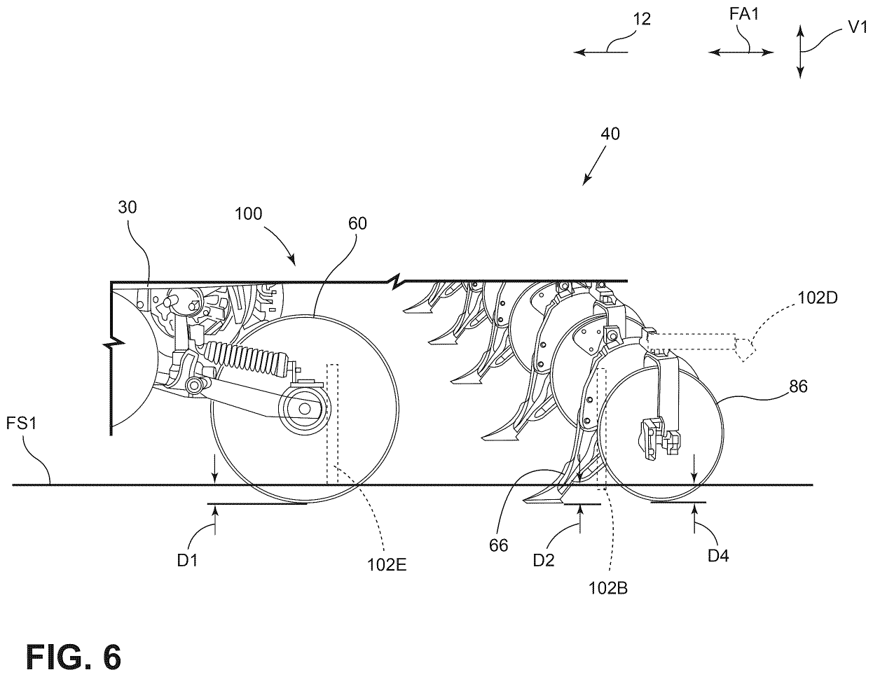

Additionally, FIG. 6 illustrates a side view of an additional embodiment of a row unit suitable for use with the implement shown in FIG. 1. The row unit 40 in FIG. 6 is, similar to the row unit 40 in FIG. 5, configured as a fertilizer row unit. The row unit in FIG. 6 includes the center coulter 60, a shank 66 generally aft of the center coulter 60 along the longitudinal direction FA1, and the side coulter discs 86 generally aft of the shank 66 along the longitudinal direction FA1, where the side coulter discs 86 may act as closing discs (to close the trench opened by the shank 66) and, optionally, condition (e.g., smooth) the surface of the field after the row unit. As such, in the embodiment shown in FIG. 6, the first dispensing device 102A, the third dispensing device 102C, and the diffusing dispensing device 102C′ are omitted compared to the embodiment shown in FIG. 2.

It should be appreciated that the further configurations of the row unit 40 described above and shown in FIG. 3-6 are not exhaustive and are provided only to place the present subject matter in an exemplary field of use. Thus, it should be appreciated that the present subject matter may be readily adaptable to any manner of row unit configuration. For instance, in further embodiments, the nutrient placement system 100 described herein may also be suitable for use on a planting implement having row-units having a plurality of ground-engaging tools, including row cleaners (like the row cleaner discs 54), an opening system (e.g., gauge wheels for setting the depth of the disc openers), closing discs, and a firmer (like the packer wheel 91), where dispensing devices 102 may be positioned at two or more of the plurality of ground-engaging tools of the planter row-unit to provide similar benefits.

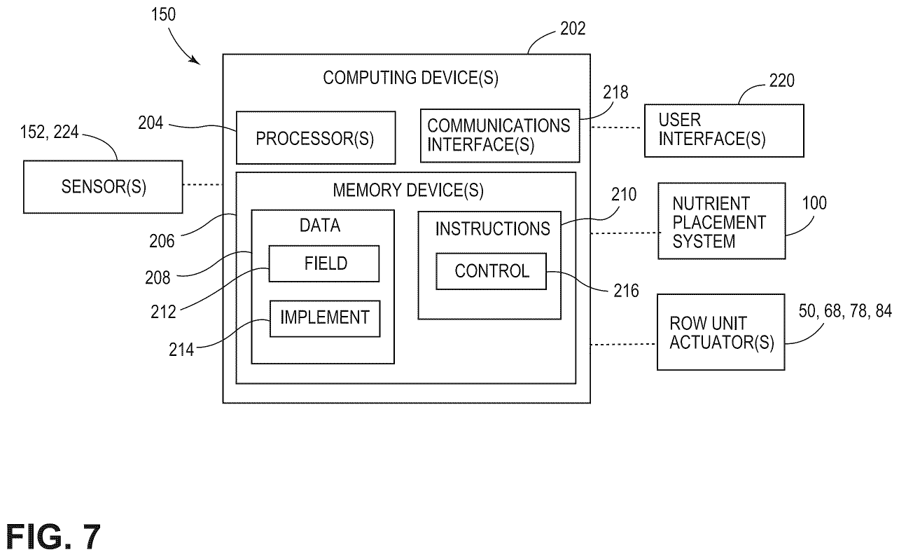

Referring now to FIG. 7, a schematic view of one embodiment of the computing system 150 for performing a nutrient placement operation during the operation of a row-unit is illustrated in accordance with aspects of the present subject matter. In general, the system 150 will be described herein with reference to the implement 10, the row units 40, and related components described above with reference to FIGS. 1-6. However, it should be appreciated that the disclosed system 150 may generally be utilized with any other implement having row units and/or with any other suitable row unit configuration.

In several embodiments, the computing system 150 may include one or more computing devices 202 and various other components configured to be communicatively coupled to and/or controlled by the computing device(s) 202, such as the sensor(s) 152, one or more user interface(s) 220 associated with the agricultural implement 10, various components of the nutrient placement system 100 (e.g., the valving assembly 108 and the distribution flow source 112), one or more of the row unit actuators 50, 68, 78, 84, and/or sensors configured to monitor one or more operating parameters associated with the operation being performed by the implement 10 and/or row units, including, but not limited to ground speed sensors, position sensors 224, flow meters, and/or the like. The user interface(s) 220 described herein may include, without limitation, any combination of input and/or output devices that allow an operator to provide inputs to the computing device(s) 202 and/or that allow the computing device(s) 202 to provide feedback to the operator, such as a keyboard, keypad, pointing device, buttons, knobs, touch sensitive screen, mobile device, audio input device, audio output device, and/or the like. Moreover, the position sensor(s) 224 described herein may include, without limitation, a satellite navigation position system (e.g. a GPS, a Galileo positioning system, a Global Navigation satellite system (GLONASS), a BeiDou Satellite Navigation and Positioning system, and/or the like), and/or a dead reckoning device, which may generate data (e.g., coordinates) indicative of an exact location of the agricultural implement 10. The computing device(s) 202 may also include a communications interface 218 to provide a means for the computing device(s) 202 to communicate with any of the various system components described herein.

It should be appreciated that the computing device(s) 202 may correspond to any suitable processor-based device(s), such as a single computing device or any combination of computing devices. Thus, as shown in FIG. 7, the computing device(s) 202 may generally include one or more processors 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and any other programmable circuits. Additionally, the memory 206 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 210 that can be executed by the processor(s) 204.

In several embodiments, the data 208 may be stored in one or more databases. For example, the data 208 may include a field database 212 for storing sensor data generated by the sensor(s) 152 and/or other relevant data that may be used by the computing device(s) 202 in accordance with aspects of the present subject matter. For instance, field condition data from previous operations (e.g., yield data from previous harvest(s)), data from manual samples and/or observations of the field conditions, prescription maps, the intended crop to be grown subsequent to the nutrient placement operation, the time of year (spring, summer, fall, winter) that the nutrient placement operation is taking place, weather conditions, and/or the like may be provided to the field database 212.

It should be appreciated that the sensor(s) 152 may be any suitable sensors for collecting data indicative of the field conditions present within the field, such as the soil type, soil moisture, nutrient composition, and/or the like. For instance, the sensor(s) 152 may include gamma ray sensor(s) configured to generate data indicative of the soil nutrient composition (e.g., potassium, thorium, uranium, and cesium within soil) and/or the soil moisture content, electromagnetic sensor(s) configured to generate data indicative of the soil nutrient composition (e.g., organic matter content and mineral composition) and the moisture content, electrochemical sensor(s) configured to generate data indicative of the soil nutrient composition (e.g., potassium, phosphorus, nitrogen, etc.), a capacitance sensor configured to generate data indicative of the soil moisture content, a ground-penetrating radar configured to generate data indicative of the soil moisture content, and/or any other suitable sensors. In some embodiments, the sensor(s) 152 may correspond to non-contact sensors. However, in other embodiments, the sensor(s) 152 may additionally, or alternatively, correspond to contact sensors. Moreover, it should be appreciated that the sensor(s) 152 may be positioned on the implement 10 (e.g., on one or more of the toolbar sections 22, 24, 26), on a vehicle towing the implement 10, on one or more of the row-units 40 supported on the implement 10, and/or on another vehicle performing passes over the field (e.g., an unmanned aerial vehicle (UAV)). Additionally, the sensor(s) 152 may have a field of view directed forward of the row units 40, towards portions of the field currently being worked by the row units 40, and/or rearward of the row units 40.

The data 208 may further include an implement database 214 configured to store data indicative of the configuration of the row units 40 on the implement, the agricultural product(s) of the nutrient placement system 100 available to the row units 40, the ground speed of the implement 10, and/or the like.

Moreover, in several embodiments, the instructions 210 stored within the memory 206 may be executed by the processor(s) 204 to implement a control module 216. In general, the control module 216 may be configured to perform control actions associated with the nutrient placement system 100. For instance, in some embodiments, the control actions may include generating a prescription map (e.g., based at least in part on the field data 212 and/or the implement data 214) to prescribe for each dispensing device 102 of a row unit 40 suitable agricultural product(s), rate of application for the prescribed agricultural product(s), and/or the depths for applying the prescribed agricultural product(s). In some embodiments, the control actions may include automatically controlling the operation of the nutrient placement system 100 and/or the row unit actuator(s) 50, 68, 78, 84 based on the field data 212 and/or the implement data 214 (and/or based on the prescription map generated), controlling the operation of the nutrient placement system 100 based on operator inputs (e.g., received via the user interface(s) 220), and/or the like. For example, the control module 216 may be configured to control the nutrient placement system 100 to provide a first agricultural product (or mixture of products) at a first rate to a first one(s) of the dispensing device(s) 102 for dispensing at a first depth, a second agricultural product (or mixture of products) at a second rate to another one(s) of the dispensing device(s) 102 for dispensing at a second depth, and optionally to provide no product at a further one(s) of the dispensing device(s). As such, product may be placed only where needed, which saves money, while improving yield.

Additionally, or alternatively, the control actions may include controlling an operation of the user interface(s) 220 to suggest actions associated with the nutrient placement system 100, such as combinations of agricultural product(s), dispensing device(s) (and associated depths), and/or application rates, such as based on the field data 212 and/or the implement data 214 (and/or the prescription map generated).

It should be appreciated that the computing system 150 may form part of a vehicle controller of a work vehicle configured to tow the implement 10, part of an associated implement controller of the implement 10, and/or may be separate of such controllers.

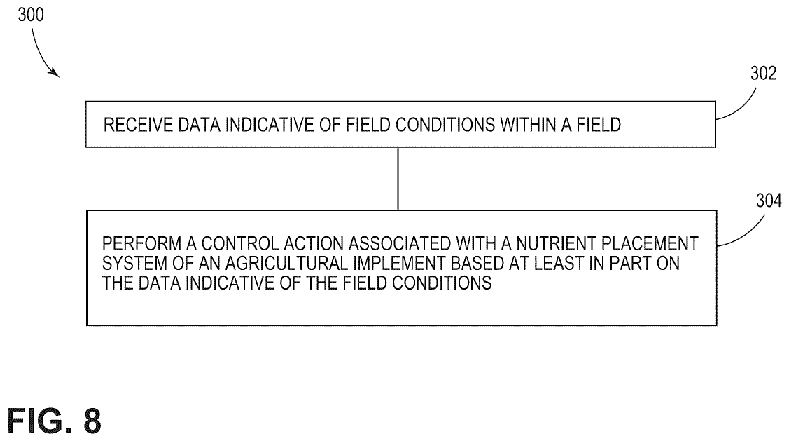

Referring now to FIG. 8, a flow diagram of one embodiment of a method 300 for performing a nutrient placement operation is illustrated in accordance with aspects of the present subject matter. In general, the method 300 will be described herein with reference to the implement 10, the row unit 40, and system 150 described above with reference to FIGS. 1-7. However, it should be appreciated by those of ordinary skill in the art that the disclosed method 300 may generally be utilized with any implement having any suitable implement configuration, any row unit having any suitable row unit configuration, and/or any system having any suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (302), the method 300 may include receiving data indicative of field conditions within a field. For instance, the computing device(s) 202 may receive the data generated by the sensor(s) 152 and/or inputs via the user interface(s) 220 indicative of field conditions within the field.

Moreover, at (304), the method 300 may include performing a control action associated with a nutrient placement system of an agricultural implement based at least in part on the data indicative of the field conditions. For instance, as described above, the computing device(s) 202 may perform a control action associated with the nutrient placement system 100 based at least in part on the data indicative of the field conditions (e.g., field data 212 in FIG. 7), the nutrient placement system 100 having a plurality of dispensing devices, such as at least a first dispensing device (e.g., first dispensing device 102A) at a first ground-engaging tool (e.g., shank 66) of a row unit and a second dispensing device at a second ground-engaging tool of a row unit (e.g., row unit 40 in FIG. 2).

It is to be understood that the steps of the method 300 are performed by the computing system 150 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 150 described herein, such as the method 300, is implemented in software code or instructions which are tangibly stored on a tangible computer readable medium. The computing system 150 loads the software code or instructions via a direct interface with the computer readable medium or via a wired and/or wireless network. Upon loading and executing such software code or instructions by the computing system 150, the computing system 150 may perform any of the functionality of the computing system 150 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural implement, comprising:
a chassis;
a row unit comprising a row unit frame supported on the chassis and a plurality of ground-engaging tools supported on the row unit frame, each of the plurality of ground-engaging tools being configured to work a field to a respective penetration depth;
a nutrient placement system comprising a plurality of dispensers supported on the row unit frame, each of the plurality of dispensers being positioned at least partially rearward of a respective ground-engaging tool of the plurality of ground-engaging tools along a forward direction of travel of the agricultural implement such that the plurality of dispensers are spaced apart along the forward direction of travel, each of the plurality of dispensers being configured to selectively dispense one or more agricultural products onto the field worked by the respective ground-engaging tool; and
a computing system configured to control operation of the nutrient placement system to selectively dispense the one or more agricultural products from the plurality of dispensers onto the field.

2. The agricultural implement of claim 1, wherein the computing system is further configured to receive data indicative of field conditions within the field,
wherein the computing system is configured to control the operation of the nutrient placement system to selectively dispense the one or more agricultural products from the plurality of dispensers based at least in part on the field conditions within the field.

3. The agricultural implement of claim 2, wherein the computing system is configured to control the operation of the nutrient placement system by controlling the operation of the nutrient placement system to selectively dispense the one or more agricultural products from each respective dispenser of the plurality of dispensers based at least in part on the field conditions within the field at the penetration depth of the respective ground-engaging tool.

4. The agricultural implement of claim 2, wherein the field conditions within the field comprise one or more of soil type, soil moisture, or nutrient composition.

5. The agricultural implement of claim 2, further comprising at least one sensor configured to generate the data indicative of the field conditions within the field.

6. The agricultural implement of claim 2, wherein the row unit further comprises one or more row unit actuators, each of the one or more row unit actuators being controllable to adjust the penetration depth of one or more respective ground-engaging tools of the plurality of ground-engaging tools into the field,
wherein the computing system is further configured to control the one or more row unit actuators to adjust the penetration depth of one or more of the plurality of ground-engaging tools based at least in part on the field conditions within the field.

7. The agricultural implement of claim 1, wherein the computing system is configured to control the operation of the nutrient placement system to adjust one or more of:
a respective mixture of the one or more agricultural products dispensed at each respective one of the plurality of dispensers; or
a respective rate of application of the one or more agricultural products dispensed at each respective one of the plurality of dispensers.

8. The agricultural implement of claim 1, wherein the plurality of dispensers comprises at least one of:
a first dispenser configured to dispense the one or more agricultural products directly into openings in the field formed by the row unit to the penetration depth of the respective ground-engaging tool; or
a second dispenser configured to diffuse the one or more agricultural products onto the field from above a field surface, the second dispenser having a wider coverage range of the field than the first dispenser.

9. The agricultural implement of claim 1, wherein the computing system is configured to control the operation of the nutrient placement system to selectively dispense the one or more agricultural products within the field based at least in part on a prescription map.

10. The agricultural implement of claim 1, wherein the computing system is configured to control the operation of the nutrient placement system to selectively dispense the one or more agricultural products from at least two of the plurality of dispensers at a time.

11. A nutrient placement system configured for an agricultural implement having a row unit comprising a row unit frame supported on a chassis and a plurality of ground-engaging tools supported on the row unit frame, each of the plurality of ground-engaging tools being configured to work a field to a respective penetration depth, the nutrient placement system comprising:
a plurality of dispensers configured to be supported on the row unit frame, each of the plurality of dispensers being configured to be positioned at least partially rearward of a respective ground-engaging tool of the plurality of ground-engaging tools along a forward direction of travel of the agricultural implement such that the plurality of dispensers are spaced apart along the forward direction of travel, each of the plurality of dispensers being configured to selectively dispense one or more agricultural products onto the field worked by the respective ground-engaging tool; and
a computing system configured to control operation of the nutrient placement system to selectively dispense the one or more agricultural products from the plurality of dispensers onto the field.

12. The nutrient placement system of claim 11, wherein the computing system is further configured to receive data indicative of field conditions within the field,
wherein the computing system is configured to control the operation of the nutrient placement system to selectively dispense the one or more agricultural products from the plurality of dispensers based at least in part on the field conditions within the field.

13. An agricultural method for operating a nutrient placement system of an agricultural implement comprising a row unit having a row unit frame supported on a chassis and a plurality of ground-engaging tools supported on the row unit frame, each of the plurality of ground-engaging tools being configured to work a field to a respective penetration depth, the nutrient placement system comprising a plurality of dispensers supported on the row unit frame, each of the plurality of dispensers being positioned at least partially rearward of a respective ground-engaging tool of the plurality of ground-engaging tools along a forward direction of travel of the agricultural implement such that the plurality of dispensers are spaced apart along the forward direction of travel, each of the plurality of dispensers being configured to selectively dispense one or more agricultural products onto the field worked by the respective ground-engaging tool, the method comprising:
receiving, with a computing system, data indicative of field conditions within the field; and
performing, with the computing system, a control action associated with the nutrient placement system based at least in part on the field conditions within the field.

14. The agricultural method of claim 13, wherein performing the control action associated with the nutrient placement system comprises controlling the operation of the nutrient placement system to selectively dispense the one or more agricultural products from each respective dispenser of the plurality of dispensers based at least in part on the field conditions within the field at the penetration depth of the respective ground-engaging tool.

15. The agricultural method of claim 13, wherein receiving the data indicative of the field conditions comprises receiving the data indicative of the field conditions, the field conditions comprising one or more of soil type, soil moisture, or nutrient composition.

16. The agricultural method of claim 13, wherein receiving the data indicative of the field conditions comprises receiving the data indicative of the field conditions, the data indicative of the field conditions being generated by at least one sensor supported on the agricultural implement.

17. The agricultural method of claim 13, wherein the row unit further comprises one or more row unit actuators, each of the one or more row unit actuators being controllable to adjust the penetration depth of one or more respective ground-engaging tools of the plurality of ground-engaging tools into the field,
the method further comprising controlling, with the computing system, the one or more row unit actuators to adjust the penetration depth of one or more of the plurality of ground-engaging tools based at least in part on the field conditions within the field.

18. The agricultural method of claim 13, wherein performing the control action associated with the nutrient placement system comprises controlling the operation of the nutrient placement system to adjust one or more of:
a respective mixture of the one or more agricultural products dispensed at each respective one of the plurality of dispensers; or
a respective rate of application of the one or more agricultural products dispensed at each respective one of the plurality of dispensers.

19. The agricultural method of claim 13, further comprising generating, with the computing system, a prescription map based at least in part on the data indicative of the field conditions and implement data,
wherein performing the control action associated with the nutrient placement system comprises controlling the operation of the nutrient placement system based at least in part on the prescription map.

20. The agricultural implement of claim 1, wherein performing the control action associated with the nutrient placement system comprises controlling a user interface associated with the nutrient placement system to suggest actions associated with the nutrient placement system.
